(19) United States
(12) Patent Application Publication
(10) Pub. No.: US 2010/0269577 A1
(43) Pub. Date: Oct. 28, 2010

(54) PYCNOMETER

(75) Inventors: Frederic Jorion, Sabran (FR); Christophe Brenneis, Saint Victor La Coste (FR); Flavie Polle, Yvrac (FR)

Correspondence Address: Nixon Peabody LLP, P.O. Box 60610, Palo Alto, CA, 94306, US

(73) Assignee: Commissariat A L'Energie Atomique Et Aux Energies Alternatives, Paris (FR)

(21) Appl. No.: 12/810,789

(22) PCT Filed: Dec. 24, 2008
(86) PCT No.: PCT/EP08/68284

§ 371 Date: Jun. 25, 2010

(30) Foreign Application Priority Data
Dec. 27, 2007 (FR) 0760396

(51) Int. Cl. G01F 17/00

(52) U.S. Cl. 73/149

(57) ABSTRACT

Device for the measurement of a sample volume comprises two chambers carved from a single slab, pressure sensors mounted on the slab and surrounded with radiation-proof shielding, and connected to the sample chamber via elbowed conduits. A temperature sensor is added. This apparatus is suitable for the measurement of the volume of radioactive samples using gas expansion inside an expansion chamber, without the radiation damaging the pressure sensors, nor heating effects that cannot be controlled.

### CROSS REFERENCE TO RELATED APPLICATIONS or PRIORITY CLAIM

This application is a national phase of International Application No. PCT/EP2008/068284, entitled “PYCNOMETER”, which was filed on Dec. 24, 2008, and which claims priority of French Patent Application No. 07 60396, filed Dec. 27, 2007.

### DESCRIPTION

The invention concerns a pycnometer, that is, a device for measuring the volume of a body, termed the sample, which is placed in a measuring chamber under gas pressure. Then, the gas is designed to be partially expanded towards an expansion chamber, which communicates with the sample chamber. Measuring the difference in pressure enables to infer the volume of the sample, providing that the volume of both chambers is known. These processes are particularly useful for determining the actual volume of porous bodies, which are easily penetrated with gas. Completed with a measurement of the sample mass, the volume indication enables to determine the volume weight or density of the body consisting of the sample.

Pycnometers are, however, subject to inaccuracies invoked in particular by the pressure sensors, estimates of volume measurements, and the presence of dead volume due to communication of the chambers with the outside. Difficulties are compounded with radioactive samples, where radiation swiftly damages commonly used gas sensors and produces heat that alters the gas pressure, and skews the measurements. Commonly used devices also prevent manipulations inside the shielded cells, where the samples are located.

U.S. Pat. No. 5,074,146, U.S. Pat. No. 4,095,473 and EP-A-0 720 011 disclose pycnometers which present such inadequacies.

The purpose of this invention is to improve those aspects of existing pycnometers, in view of obtaining more precise measurement, and risk-free manipulations even for radioactive samples.

In one particular embodiment, the invention concerns a pycnometer comprising two communicating chambers, one of which is a sample chamber, and the other an expansion chamber, two pressure sensors respectively associated with the chambers, and valves enabling both chambers to communicate with each other and with the outside, or to isolate them, characterized in that the chambers are carved out of the same slab, the pressure sensors are mounted on the slab, surrounded by a radiation shield, the pressure sensor associated with the sample chamber is connected to said chamber with an elbow conduit, and there is a sample chamber temperature sensor.

The device appears of massive shape, both solid and unitary, which makes it easy to manipulate. The shielding and the elbow of the conduit enable isolation of the sensors from radiation, as they prevent direct exposure to the sample chambers. The temperature sensor affords the application of corrections. Finally, the carving out of chambers from a single slab ensures the accuracy of their volume.

According to another improvement, the chambers communicate with each other, with the outside, with the temperature sensor and the pressure sensors, exclusively via conduits consisting of bores, factory-drilled through the slab, and eventually via mounting surfaces separating parts of the slab, which are assembled together via tightening or bolting.

Since said factory-drilled bores through the body are very fine, the dead volumes of the conduit network will be reduced, and otherwise may be determined with precision.

According to another improvement, the valves comprise pistons that slide inside the bores of the slab, the bores containing a base into which two conduits extend.

This feature also reduces dead volumes of the network, ensuring the accuracy of measurements and enabling easy control.

It is also advantageous, in view of improving manipulation of the pycnometer, that the body comprise devices to activate the valves, and a device that opens and closes the sample chamber.

Finally, the accuracy of measurement may also be improved if the apparatus comprises a device for varying the volume of the expansion chamber.

The invention will now be described in all of its aspects in light of a particular embodiment, in regards to the figures:

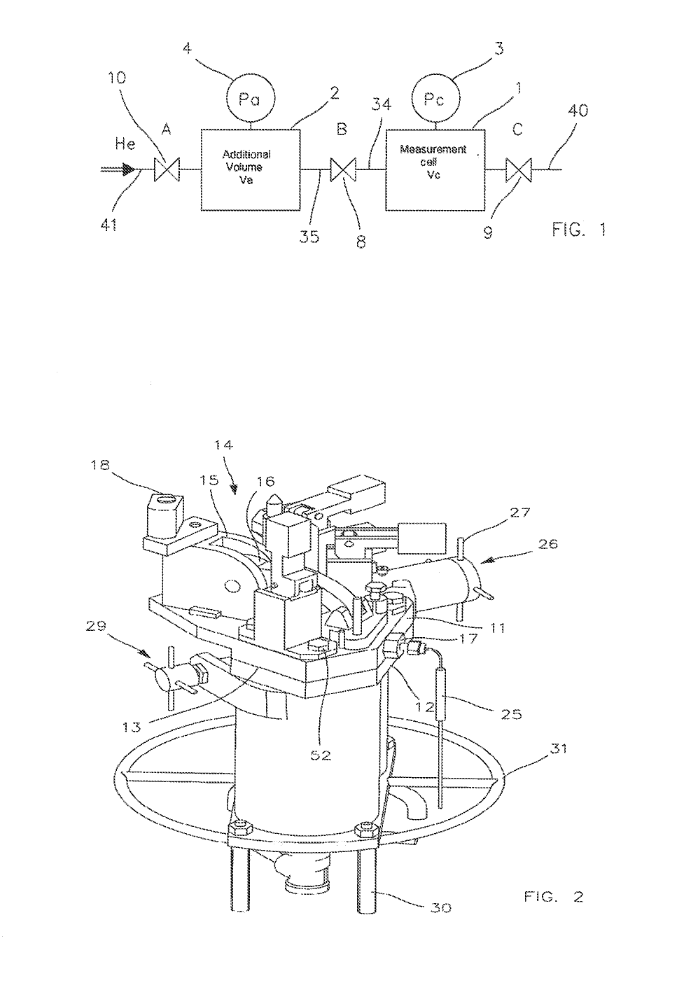

FIG. 1 represents a block diagram of a pycnometer, and

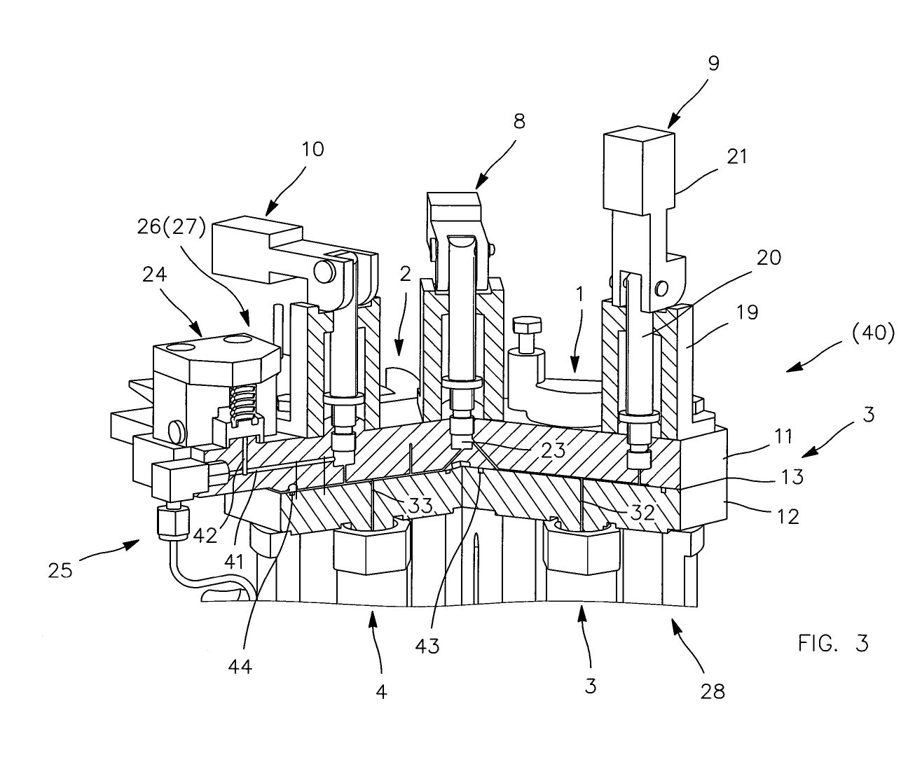

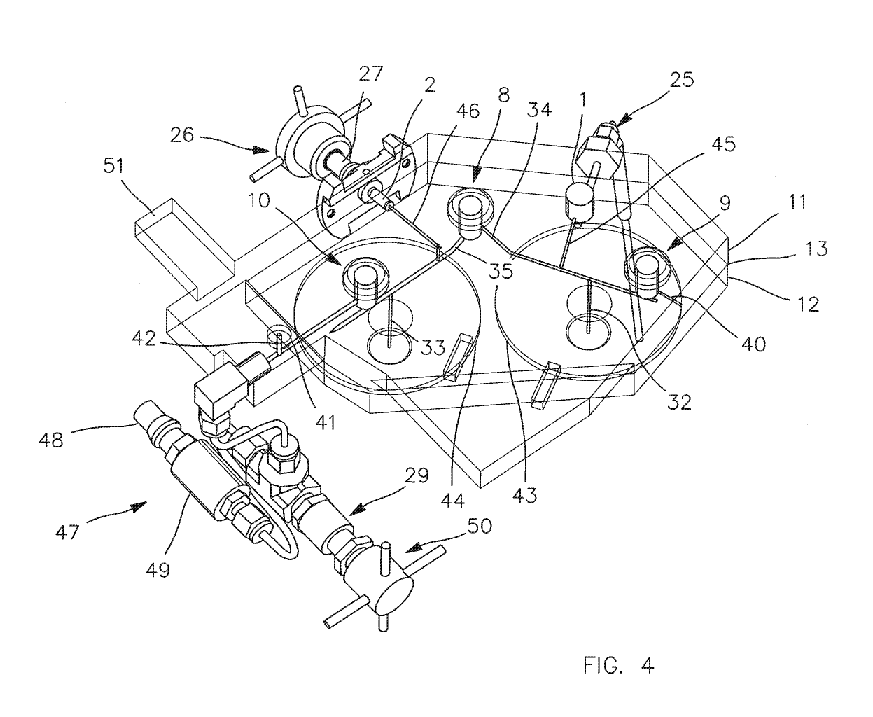

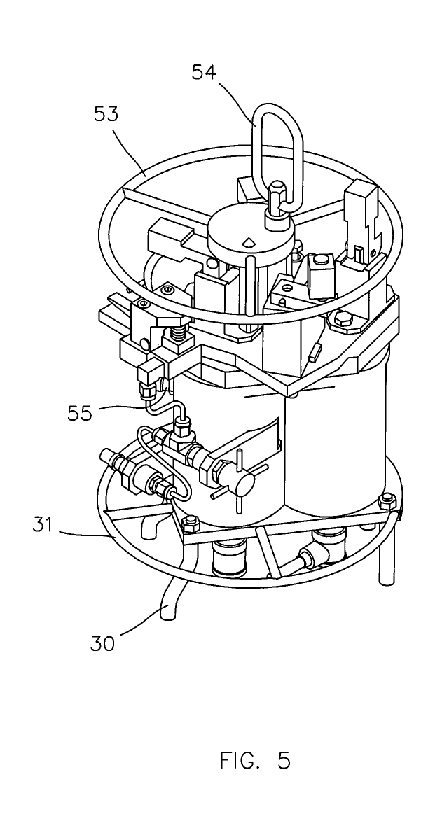

FIGS. 2, 3, 4 and 5 illustrate the more particular embodiment suggested here, where FIG. 2 represents an outside view, FIG. 3 represents a profile view, FIG. 4 represents a partial view illustrating position of the main elements and the network of supplier conduits, and FIG. 5 represents a complete view from the outside.

According to FIG. 1, the system consists of a sample chamber 1, an expansion chamber 2, two pressure sensors 3 and 4, respectively associated with the chambers 1 and 2. A communication conduit 34, between chamber 1, the pressure sensor 3, and valves 8 and 10, and a conduit 35, between chamber 2, the pressure sensor 4, and valves 8 and 10, comprise the gas network. Conduits 40 and 41 respectively enable venting of valve 9, and gas input to the apparatus. If V designates the volume of a sample placed inside the sample chamber 1, V1 and V2 designate the volumes of chambers 1 and 2, P1 and P2 designate the pressure of the chambers 1 and 2, prior to expansion, and PF designates the common pressure of the chambers following communication and expansion, the following formula yields the sample volume: V=V1+(PF−P2/PF−P1).V2.

We will now proceed with commenting FIGS. 2, 3, 4 and 5. The core of the apparatus is a slab 36, consisting of an upper cylinder head 11, and lower cylinder head 12, pressed together on a mounting surface 13. The equipment of the apparatus appears mainly on the upper surface of the upper cylinder head, but a few are mounted on the periphery of slab 36, around the mounting surface 13, and on the lower surface of the lower cylinder head 12.

The sample chamber 1, and the expansion chamber 2, are factory-engineered inside the upper cylinder head 11; the sample chamber 1 opens on the upper side of the upper cylinder head 11, but it may be shut via movement of a flange 14, comprising a cover 15, mounted on the cylinder head 11, a lever 16 rotating on the cover 15, a door 17 articulated to the upper cylinder head is pinned to the cylinder head, to the right of the sample chamber 1, using a lever 16, and a crank 18 to lock the lever 16.

The valves 8, 9 and 10 comprise a tube 19, bolted to the upper cylinder head 11, a pin 20 sliding inside the tube 19, a crank 21 mounted on top of the tube 19, which causes the piston 20 to slide through the bore 23 of the upper cylinder head 11, each time ensuring either obstruction or communication of the conduits 34 and 35, as will be described subsequently. The fastening screws 52 of valves 8, 9 and 10 enable pressing of the cylinder heads 11 and 12 against each other on the mounting surface 13. The upper cylinder 11 also supports a vent 24 which may be actuated by a handle on the upper side, and on the periphery a thermocouple 25 under the sample chamber 1, and a volume-adjusting device 26 for the expansion chamber 2, comprising a micrometer screw 27 that penetrates inside.

The lower cylinder head 12 essentially supports the pressure sensors 3 and 4, surrounded by a radiation-proof shield 28, and a flow controller 29, equipped with a drive capstan 50. The shielding 28 is equipped with a connection 55, enabling to connect a gas inlet, in view of ventilating the pressure sensors for the purpose of cooling them. The shielding 28 supports a guiding ring 31 to facilitate the horizontal manipulation of the apparatus, inside the tunnel. An identical, though removable, guiding ring 53, is installed during horizontal manipulations, to maintain guidance and maximum protection of the apparatus. After opening the inside door of the tunnel, the apparatus is grasped by its lifting ring 54, using an existing means of manipulation, inside the shielded cell (a hoist). It is then deposited on the bottom of the cell, and is supported by 4 feet 30. The lifting ring 54 and the guiding ring 53 are then removed.

We will now proceed to describe the internal layout of slab 36. Conduits 32 and 33 are pierced with a fine radius through the lower cylinder head 12, extending to pressure sensors 3 and 4. Other fine conduits 34 and 35 are pierced through the upper cylinder head 11, between the lower side and the bores 23 of the valves, with 34 extending from valve 8 to valve 9, and 35 extending from valve 8 to valve 10. Two fine conduits 45 and 46 are also pierced through the lower side of the upper cylinder head 11 and, respectively, the sample chamber 1 and the expansion chamber 2. A conduit 40 is pierced through the upper cylinder head 11, between the side of bore 23 of valve 9 and the outside, and functioning as a lower vent; a conduit 41 is pierced through the upper cylinder 11, between the side of bore 23 and valve 10, and the outside, and connects to a gas inlet device 47, which may include a connector 48, screwed to a part 49, linked to the pressure sensor shielding, supplying rigidity during connections and disconnections of the inlet gas piping, and the flow controller 29; finally, the network comprises a conduit 42 branching off from conduit 41 and connecting to vent 24. This vent opens using the cell's remote handling tong by pinning its maneuvering rod on a protuberance 51 of the upper cylinder head. All of said conduits are also pierced with fine diameters.

Conduits 34 and 45 extend to an area of the mounting surface 13, which is surrounded by a seal 43, sandwiched between the cylinder heads 11 and 12. Likewise, conduits 35 and 46 extend to an area of the mounting surface 13 which is surrounded by another seal 44. Conduits 34 and 35, which are used as connection conduits between the conduits pierced through the two cylinder heads 11 and 12, each have a portion carved into the lower side of the upper cylinder head, and thus opening into the mounting surface 13, which facilitates establishing all of the connections. Said portions are included inside the edge of the seals 43 and 44, which thus prevents leaks via the mounting surface 13.

Dead volumes of the apparatus thus include the manufactured bores of the slab mass 36, the volume of which is low due to the fine diameters of the bores, the areas covered with seals 43 and 44, the volume of which is also low due to the small amount of loosening of the mounting surface 13, and the bore volumes 23, which are also low due to the small amount of movement required for piston 20 to establish communication between the pairs of conduits extending to the bottom of bores 23 (34 and 35) and at the bottom of their lateral side (35, 40 and 41). Said dead volumes are otherwise specified with accuracy due to high quality factory-engineering.

The pressure sensors 3 and 4 are far from sample chamber 1, and thus unlikely to be damaged by radiation, primarily due to the shielding 28, and secondarily due to the elbows between conduits 32, 34 and 4, between the sample chamber 1 and the associated pressure sensor 3, which prevents irruption of radiation; the path to the other pressure sensor 4 is obviously even more sinuous.

The thermocouple 25 communicates almost directly with the sample room 1 via a communication bore, carved into the upper cylinder head 11, and which was plugged back to become impervious to gas. Gas temperature measurements are thus accurate.

Instructions for use of the pycnometer and measurements are conventional: the samples are placed inside chamber 1, which is then shut, and the volume of the expansion chamber 2 is adjusted; a gas cylinder (unrepresented) is connected to the connector 48 and the gas fills both chambers 1 and 2, the vent 9 being closed; pressure of the chambers is adjusted with the flow controller 29; when the required pressure is obtained, vent 8 is closed to isolate sample room 1, and the excess pressure of the expansion chamber 2 is released by actuating vent 24, while vent 10 is closed; vent 8 is then opened, and measurements begin. However, pressure measurements are preferably recorded continuously during the whole course of the experiment, as well as temperature measurements, in view of correcting pressure, so that the portion due to temperature may be subtracted; this being calculated using the definition formula for ideal gases.

The cranks 18 and 21 are maintained with the apparatus using remote-handling means, the dexterity of which is thus quite rudimentary, and likewise the micrometric screw and the flow controller 29 may easily be turned due to the installation of capstans 27 and 50 on the operating button.

1. Pycnometer comprising two communicating chambers, one which is a sample room and the other an expansion room, two pressure sensors, respectively associated with the chambers and vents so the chambers communicate with each other and with the outside, or to isolate them, characterized in that the chambers are carved out of a single slab during manufacture, the pressure sensors are mounted on the slab, surrounded by a radiation-proof shield, the pressure sensors are connected to said sample chamber via elbowed conduits, and there is a temperature sensor for the sample chamber.

2. Pycnometer according to claim 1, characterized in that the chambers communicate with each other, with the outside, with the pressure sensors, exclusively via conduits consisting of bores factory-engineered into the slab.

3. Pycnometer according to claim 1, characterized in that the vents comprise pistons that slide inside bores of the slab, the bores each containing a base to which one of the conduits extends, and a lateral side, at the base of which another conduit extends.

4. Pycnometer according to claim 1, characterized in that the slab comprises a single side on which the actuating devices of the vents are located, and an opening and closing device for the expansion chamber.

5. Pycnometer according to claim 1, characterized in that it comprises a device for varying the volume of the expansion room.

6. Pycnometer according to claim 1, characterized in that the slab comprises parts, assembled together via bolting and tightening at a mounting surface.

7. Pycnometer according to claim 2, characterized in that certain conduits comprise portions that extend to the mounting surface.

8. Pycnometer according to claim 7, characterized in that said portions extending to the mounting surface are included inside the edge of the circular seals installed between parts of the slab.

9. Pycnometer according to claim 7, characterized in that said portions extending to the mounting surface are connected to other conduits pierced through the slabs, between the mounting surface, and either the chambers, the pressure sensors, or the vents.
